(19) United States
(12) Patent Application Publication
(10) Pub. No.: US 2026/0065205 A1
(43) Pub. Date: Mar. 5, 2026

(54) USING A GENERATIVE MODEL TO GENERATE A REPORT IDENTIFYING USER INTERACTIONS WITH TASKS DURING A SPECIFIED TIME INTERVAL

(71) Applicant: Mango Technologies, Inc. DBA ClickUp, San Diego, CA (US)

(72) Inventors: Erich Elendt, Toronto (CA); Daniel Gornstein, San Diego, CA (US); Hariharan Rajagopalan, Mountain View, CA (US)

(21) Appl. No.: 18/816,916

(22) Filed: Aug. 27, 2024

(51) Int. Cl. G06Q 10/0639

(52) U.S. Cl. CPC G06Q 10/0639

(57) ABSTRACT

A task management system maintains tasks for performance by associated performing users. Each task has a set of attributes, and a performing user interacts with a task to modify a value of an attribute when the performing user works on a task. To track performance of tasks by a performing user, the task management system generates a standup report identifying interactions with tasks by the performing user during a specific time interval. The task management system identifies a set of tasks with which the performing user performed at least one interaction during the specific time interval and ranks the set of tasks based on task-specific relevance scores. A relevance score for a task is based on attributes of the task. A prompt including interactions with tasks ranked by relevance scores is provided to a generative model, which generated the standup report.

### BACKGROUND

In many collaborative environments, such as product development, multiple users perform actions to complete a project. Often, different users perform different actions, with the completed actions of different users being combined to create the product. To monitor the progress of various actions performed by different users, a user may generate a task stored in a computer system. A task corresponds to an action and assigns a performing user to perform the task. Performing users interact with a task to modify one or more attributes of the task. Modifications to one or more attributes of the task because of the interaction provide information about performance of the task.

To monitor performance of different tasks over time, a user may request a report for one or more performing users. A report for a performing user identifies tasks with which the performing user performed one or more interactions during a specific time interval and descriptions of the interactions performed with each task by the performing user.

Conventionally, a performing user manually generates such a report by reviewing data stored by the computer system identifying interactions performed by the performing user to identify interactions changing one or more attributes of a task. Alternatively, a user manually reviews data stored by the computer system to identify interactions performed by the performing user with different tasks. This manual generation of reports describing interactions with tasks by one or more performing users over time is time-intensive for a performing user or for a user, which may prevent a user from maintaining accurate information about performance of tasks by performing users.

### SUMMARY

In accordance with one or more aspects of the disclosure, a task management system receives tasks from users. Each task identifies an action to be performed and includes a performing user assigned to perform the action. Further, each task is associated with one or more attributes that provide information about the task. In various embodiments, the task management system stores a task log in a data store to identify received tasks. In various embodiments, the task log includes multiple entries, with each entry corresponding to a task. An entry in the task log includes a task identifier of a task, a performing user assigned to perform the task, and one or more attributes of the task. Additionally, an entry in the task log corresponding to a task includes multiple attributes of the task. Example attributes of a task include: an identifier of a performing user assigned to perform the task, a status of the task, a due date for the task, a priority level of the task, a resource allocation (e.g., a budget) for performing the task, one or more comments about the task, or other information relevant to performing an action corresponding to the task.

As a performing user performs an action corresponding to a task, the performing user performs one or more interactions with the task that modify one or more attributes of the task. For example, an interaction with a task modifies a value of one or more attributes of the task or generates an additional attribute for the task. In an example, an interaction with the task changes a value of a status of the task or includes a comment for the task. Hence, interactions with a task provide information about progress on performance of an action corresponding to the task.

As performing users perform interactions with tasks, the task management system generates an interaction log comprising entries that each correspond to an interaction with a task by a user. In various embodiments, the interaction log includes multiple entries that each store an identifier of an interaction, a user who performed the interaction, a task identifier of a task on which the interaction was performed, a time when the interaction was performed, and a description of the interaction. Different information describing an interaction with a task may be included in an entry in the interaction log.

To monitor performance of actions for different tasks, a user may request a standup report for a performing user during a specific time interval. The standup report identifies interactions that the performing user performed with tasks during the specific time interval. In various embodiments, the standup report identifies each task with which the performing user performed an interaction during the specific time interval and includes a description of the interactions the performing user performed with each task during the specific time interval. Conventionally, a performing user manually identifies interactions with tasks that were performed during the specific time interval, or the user requesting the standup report reviews individual tasks they performed during the specific time interval to identify interactions performed by the performing user. However, these conventional methods are time- and labor-intensive for the performing user or for the user requesting the standup report.

The task management system simplifies generation of a standup report for a performing user by leveraging the task log and the interaction log. The task management system receives a request for a standup report that identifies a performing user and a specific time interval. For example, a user selects an interface element for generating a standup report in an interface displayed by a client device and inputs a user identifier of the performing user and the specific time interval via the interface. Based on the received input, the client device transmits a request including the user identifier of the performing user and the specific time interval to the task management system. However, in other embodiments, the user generates the request using additional or alternative methods.

In response to receiving the request, the task management system identifies a set of tasks based on the request and the interaction log. The set of tasks includes tasks with which the performing user included in the request performed at least one interaction during the specific time interval included in the request. In various embodiments, the task management system 130 identifies entries in the interaction log including interactions performed by the performing user included in the request during the specific time interval included in the request and identifying tasks included in the identified entries to identify the set of tasks. In some embodiments, the set of tasks includes tasks with which the performing user included in the request performed an interaction that modified an attribute of a task during the specific time interval included in the request; such embodiments limit the set of tasks to tasks having at least one attribute modified by an interaction performed by the performing user included in the request during the specific time interval included in the request.

While the set of tasks includes tasks with which the performing user included in the request performed an interaction during the specific time interval included in the request, interactions with different tasks have different levels of relevance to the user from whom the request was received. For example, an interaction by the performing user included in the request with a task that is assigned to the performing user included in the request is more relevant to the user from whom the request was received evaluating the performing user included in the request than an interaction by the performing user included in the request with another task assigned to a different performing user. To account for variations in relevance of different interactions by the performing user when generating the standup report, the task management system determines a relevance score for each task of the set and ranks the tasks of the set by their corresponding relevance scores. A relevance score for a task of the set is based on values of attributes of the task of the set.

In various embodiments, the task management system associates different weights with different attributes of a task. To determine a relevance score for the task, the task management system applies a corresponding weight for an attribute to a value of the attribute and combines the weighted values of the attributes. For example, the relevance score for a task is a weighted sum of values of attributes of the task with corresponding weights applied. However, in other embodiments, the task management system may differently combine the weighted values of attributes of the task. In various embodiments, a higher weight corresponding to an attribute of the task indicates the attribute provides a greater indication of whether the task is relevant to the user from whom the request was received. For example, an attribute indicating whether a task was assigned to the performing user included in the request has a maximum weight.

The task management system may apply a trained generative model to the attributes of tasks when determining weights for different attributes. The generative model is pre-trained on a large text corpus before being obtained by the task management system. For example, the generative model is a large language model (LLM), such as a generative pre-trained transformer (GPT) language model. Based on the pre-training, the generative model learned relationships between different portions text and leverages the learned relationships to generate output text in response to a received text prompt. The task management system generates a ranking prompt for the generative model that identifies each attribute of a task and a request to select a subset of attributes relevant to the user. In some embodiments, the ranking prompt includes a request to rank the subset of attributes. The generative model generates a ranking of attributes of tasks, and the task management system determines weights for attributes based on the ranking of attributes, with attributes having higher positions in the ranking having larger weights. The task management system subsequently applies the determined weights for different attributes to corresponding values of the different attribute for a task to generate the relevance score for the task.

Based on the relevance score for each task of the set, the task management system ranks the tasks of the set. When ranking the tasks of the set, tasks with higher relevance scores have higher positions in the ranking in various embodiments. Based on the ranking of the tasks of the set, the task management system generates a prompt for the generative model. The prompt includes each task of the set in the order specified by the ranking. In various embodiments, the prompt includes a request to generate the standup report. In conjunction with each task of the set, the prompt includes interactions by the performing user included in the request with a corresponding task of the set during the specific time interval included in the request. The prompt includes the tasks of the set in the order specified by the ranking. Hence, the prompt includes interactions by the performing user included in the request with tasks during the specific time interval included in the request, with the interactions grouped based on a task with which they were performed, and the tasks of the set ordered based on the ranking. In various embodiments, the prompt includes text data identifying each task of the set and describing corresponding interactions with tasks of the set by the performing user included in the request during the specific time interval included in the request.

The generative model receives the prompt, which comprises text, and generates text content based on the prompt. In various embodiments, the generative model is a large language model (LLM), such as a generative pre-trained transformer model (GPT). In some embodiments, the task management system uses a common generative model to rank attributes of a task and to generate the standup report. Alternatively, different generative models are used to rank attributes of a task and to generate the standup report. The generative model is pre-trained on a text corpus including text to output text in response to a text prompt from a user prior to being stored by the task management system, with the pre-training allowing the generative model to generates output based on a received prompt and relationships between text the generative model learned when applied to the text corpus. Hence, based on the prompt, the generative model generates the standup report that identifies each task of the set and interactions by the performing user included in the request with each task of the set during the specific time interval included in the request.

In some embodiments, the prompt also includes a formatting instruction that is appended to the interactions by the performing user included in the request with tasks of the set during the time interval included in the request. The generative model uses the formatting instruction to determine how to group and to display the tasks of the set and corresponding interactions with tasks of the set by the performing user identified in the request for presentation in the standup report. For example, a particular value for the formatting instruction causes the generative model to generate a standup report displaying interactions with a task of the set as a bulleted list associated with the task of the set. In other examples, different formatting instructions modify an amount of detail the standup report displays for various interactions with tasks of the set.

The formatting instruction may be an example appended to the interactions by the performing user included in the request with tasks during the specific time interval included in the request. The example includes example tasks and interactions and an example format displaying the example tasks and interactions. In some embodiments, the task management system receives a selection of a formatting instruction from a set of formatting instructions displayed to the user, retrieves an example corresponding to the selected formatting instruction, and includes the retrieved example in the prompt. This allows the user requesting the standup report to customize how the standup report identifies interactions by the performing user identified in the request and to leverage one or more formatting configurations maintained by the task management system. Alternatively, the user from whom the request was received may manually specify the formatting instruction. For example, the user includes a user-generated example including example tasks and interactions and an example report displaying the example tasks and interactions to further personalize how the standup report displays interactions by the performing user included in the request with tasks of the set.

For example, the standup report identifies each task of the set. In conjunction with each task of the set, the standup report displays information describing interactions with a task of the set by the performing user included in the request during the specific time interval included in the request. As an example, the standup report displays a task name or a task identifier and displays information describing at least a set of interactions the performing user identified by the request performed with the task corresponding to the task name or the task identifier during the specific time interval included in the request.

While the task management system simplifies generation of the standup report by identifying the set of tasks based on interactions by the performing user included in the request with tasks during the specific time interval included in the request, the task management system also orders the tasks of the set so the standup report more prominently presents interactions providing more information about performance of actions. Ordering the tasks of the set, and their corresponding interactions, based on relevance scores of the tasks allows the prompt provided to the generative model to represent relative importance of the tasks of the set to each other. As many generative models may be inaccurate when reordering data in a prompt, ordering the tasks based on their relevance scores allows the resulting standup report to preserve the ordering of the tasks. Basing relevance scores for tasks on values of attributes for the tasks weighted by attribute-specific weights allows the task management system to use different attributes of tasks as a proxy for the likely relevance of a task to a user requesting the standup report.

### BRIEF DESCRIPTION OF THE DRAWINGS

FIG. 1 illustrates an example system environment for a task management system, in accordance with one or more embodiments.

FIG. 2 illustrates an example system architecture for a task management system, in accordance with one or more embodiments.

FIG. 3 illustrates a flowchart of a method for generating a standup report identifying interactions performed by a user with tasks during a specified time interval, in accordance with one or more embodiments.

FIG. 4 illustrates a process flow diagram of a method for generating a standup report identifying interactions performed by a user with tasks during a specified time interval, in accordance with one or more embodiments.

### DETAILED DESCRIPTION

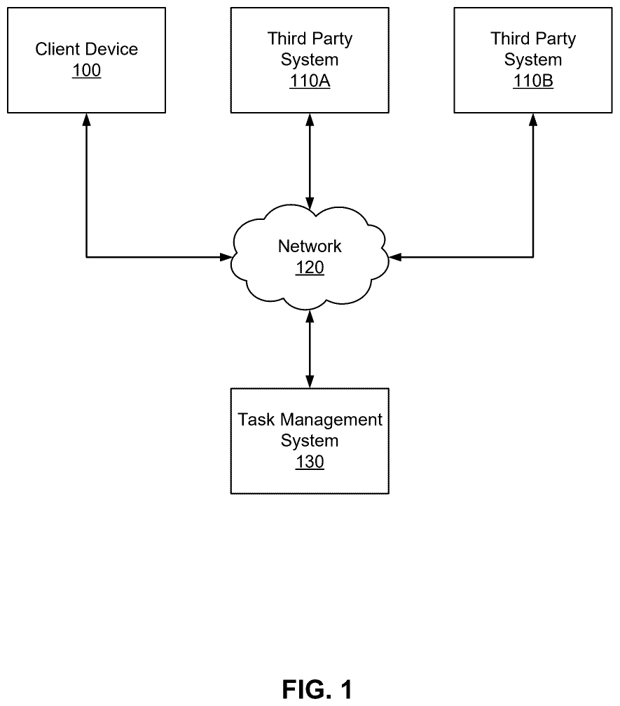

FIG. 1 illustrates an example system environment for a task management system 130, in accordance with one or more embodiments. The system environment illustrated in FIG. 1 includes a client device 100, one or more third party systems 110A, 110B (also referred to individually and collectively using reference number 110), a network 120, and a task management system 130. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

For purposes of illustration, FIG. 1 shows a single client device 100 for purposes of illustration. However, any number of client devices 100 may be included in the system environment. As such, there may be more than one client device 100 in various embodiments. The client device 100 is a device through which a user may interact with one or more third party systems 110 or with the task management system 130. The client device 100 may be a personal computing device or a mobile computing device, such as a smartphone, a tablet, a laptop computer, or desktop computer. In some embodiments, the client device 100 executes a task management application that uses an application programming interface (API) to communicate with the task management system 130.

Through interaction with the task management application executing on the client device 100, a user creates one or more tasks that are stored by the task management system 130, as further described below. Each task corresponds to one or more actions to be performed, and a performing user is assigned to a task. The performing user is assigned to complete the one or more actions corresponding to a task. The performing user may be the user who created the task or may be a different user. Additionally, the user may specify one or more attributes of a task, as well as values of one or more attributes. Example attributes of a task include the performing user assigned to the task, a status of the task, a due date for the task, a priority level of the task, a resource allocation (e.g., a budget) for performing the task, one or more comments about the task, one or more users authorized to view the task, or other information relevant to performing an action corresponding to the task.

In various embodiments, the task management application executing on the client device 100 presents a workflow management interface to the user. The workflow management interface is a user interface that receives input from the user to identify tasks, to create tasks, to generate a list of related tasks, to generate a hierarchy of tasks, to assign a performing user to a task, to modify one or more attributes of a task, or to perform other interactions affecting one or more tasks. In various embodiments, the workflow management interface allows the user to search the task management system 130 for tasks satisfying one or more attributes specified by the user and accessible to the user. The workflow management interface also allows a user to generate one or more reports describing tasks, such as a report identifying interactions with one or more tasks performed by an identified performing user. Additionally, the workflow management interface includes one or more messaging elements allowing the user to provide messages for transmission to one or more receiving users of the task management system 130.

In some embodiments, the task management application also generates and presents a communication interface to the user that allows the user to communicate messages to the task management system 130, to a receiving user of the task management system 130, or to a third party system 110. A message may include text data, audio data, image data, video data, or any combination thereof. For example, a message is a text message or a chat message. The client device 100 transmits a message via the network 120 and may receive one or more messages via the network 120. The communication interface may also display messages received from the tsk management system 130, from a third party system 110, or from another client device 100 to the user. In some embodiments, the communication interface may allow the user of the client device 100 and another user to communicate through audio or video communications, such as a phone call, a voice-over-Internet-Protocol call, or a video call.

The client device 100 may receive additional content from the task management system 130 to present to a customer. For example, the client device receives notifications from the task management system 130 and presents the notifications to the customer. For example, a notification received from the task management system 130 identifies a modification to attribute of a task associated with the user (e.g., a change in a status of the task).

A third party system 110 is a computing system separate from the task management system 130 that interacts with the task management system 130 or with the client device 100. In various embodiments, different third party systems 110A, 110B provide different types of content to the task management system 130 or to the client device 100. For example, a third party system 110 is an application provider communicating information describing one or more applications for execution by a client device 100 or communicating data to a client device 100 for use by an application executing on the client device 100. In other embodiments, a third party system 110 provides content (e.g., web pages, video content, etc.) or other information for presentation via a client device 100. A third party system 130 may also communicate information to the task management system 130, such as files, documents, metadata, or other information to the task management system 130.

The client device 100, the one or more third party systems 110, and the task management system 130 can communicate with each other via the network 120. The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as multiprotocol label switching (MPLS) lines, fiber optic cables, cellular connections (e.g., 3G, 4G, or 5G spectra), or satellites. The network 120 also may use networking protocols, such as transmission control protocol/internet protocol (TCP/IP), hypertext transfer protocol (HTTP), secure shell protocol (SSH), short message service (SMS), multimedia messaging service (MMS), rich communication services (RCS) or file transfer protocol (FTP), to transmit data between computing devices. In some embodiments, the network 120 may include BLUETOOTH® or near-field communication (NFC) technologies or protocols for local communications between computing devices. The network 120 may transmit encrypted or unencrypted data.

The task management system 130 is an online system where users identify tasks specifying actions to be performed, assign a performing user to perform an action identified by a task, and specify attributes of the task. The task management system 130 maintains associations between users and tasks. For example, the task management system 130 stores an association between a task identifier of a task, one or more user identifiers of performing users associated with the task, and a user identifier of a user who created the task. The task management system 130 receives an interaction with a task from a user and modifies one or more attributes of the task based on the interaction. Additionally or alternatively, the task management system 130 may modify one or more attributes of a task based on received information describing interactions performed by a user. In some embodiments, the task management system 130 transmits a notification to a client device 100 of a user associated with a task in response to an attribute of the task being modified to inform the user associated with the task when an attribute of the task is modified.

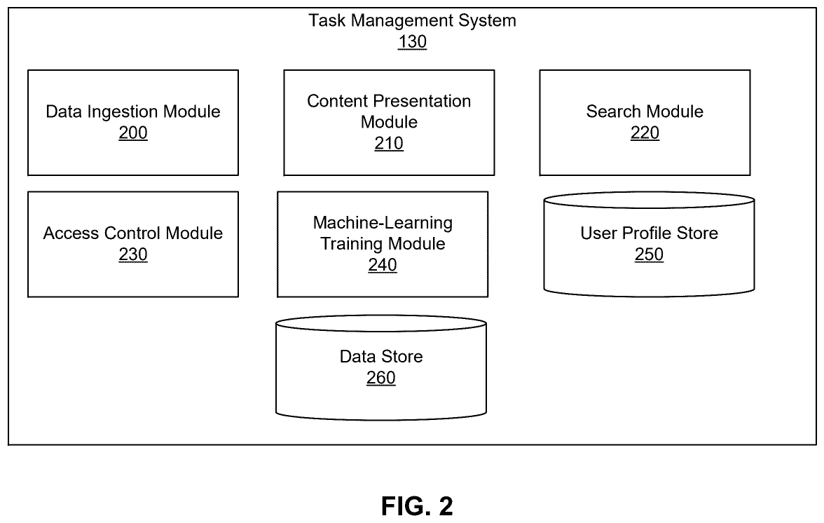

Additionally, the task management system 130 may generate one or more interfaces for a user associated with one or more tasks. For example, an interface identifies tasks associated with a user and identifies at least a set of attributes of the identified tasks, allowing the user to readily review and identify attributes of different tasks. The interface may identify relationships between tasks or between tasks and one or more sub-tasks of a task identified by a user, allowing the user to readily ascertain relationships between different tasks. Further, the task management system 130 may store files or other data associated with a task or store information for retrieving files or data associated with the task from a third party system 130 to simplify access to data for reviewing or for performing a task for a user. The task management system 130 is described in further detail below with regard to FIG. 2.

FIG. 2 illustrates an example system architecture for a task management system 130, in accordance with some embodiments. The system architecture illustrated in FIG. 2 includes a data ingestion module 200, a content presentation module 210, a search module 220, an access control module 230, a machine learning training module 240, a user profile store 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data ingestion module 200 collects data used by the task management system 130 and stores the data in the user profile store 250 or in the data store 260. For example, the data ingestion module 200 receives information for creating a task from a user. Information for creating a task includes a description of the task, a performing user assigned to the task, and one or more attributes of the task. Values of one or more attributes may also be received from the user, or the data ingestion module 200 may specify default values for one or more attributes of a task. The data ingestion module 200 also receives modifications to one or more values of attributes of a task from a user. Additionally, the data ingestion module 200 receives information from a user including characteristics of a user for inclusion in a corresponding user profile. The data ingestion module 200 may encrypt some or all of the obtained data, such as certain data describing a user.

The data ingestion module 200 also receives data describing relationships between tasks from a user or from a third party system 110. For example, a user may identify one or more discrete sub-tasks that correspond to different portions of a task, and the data ingestion module 200 extracts information identifying the task and the sub-tasks associated with the task. Further, the data ingestion module 200 may receive data describing a hierarchy of tasks. For example, the data ingestion module 200 receives an identifier of a list from a user along with identifiers of one or more tasks to associate with the list. Hence, the list includes one or more tasks, allowing a user to organize related tasks, tasks related to a common objective, or tasks having one or more other common criteria. Additional hierarchical information may be specified in some embodiments. For example, the data ingestion module 200 receives an identifier of a category and identifiers of one or more lists associated with the category, allowing a user to generate a grouping of lists, and the tasks included in the lists. Received data describing a hierarchical relationship between tasks is stored in the data store 260 by the data ingestion module 200.

Additionally, the data ingestion module 200 captures interactions by users with tasks and stores the interactions in an interaction log included in the data store 260. In various embodiments, when a user interacts with a task through the task management system 130, the data ingestion module 200 determines a user identifier of the user, a task identifier of the task with which the user interacted, a time when the interaction occurred, and a description of the interaction by the user with the task. When the interaction with a task modifies a value of an attribute of the task, the description of the interaction by the user includes an identifier of the attribute of the modifier of the task and the modified value of the task. In some embodiments, the description of the interaction includes an indication that the interaction changed at least one attribute of the task and may identify the attribute that was changed. Capturing interactions by users with tasks allows the data ingestion module 200 to populate the interaction log in the data store 260, providing a history of interactions with tasks by users over time.

The content presentation module 210 selects content for presentation to a user and generates one or more interfaces for displaying the content to the user. In various embodiments, the content presentation module 210 receives a request for content from the user including one or more criteria, selects one or more tasks having attributes satisfying one or more of the criteria, and generates an interface displaying information about the selected one or more tasks to the user. The content presentation module 210 generates instructions for generating an interface and transmits the instructions to a client device 100, which executes the instructions to generate an interface presenting the information to a user (e.g., information about one or more tasks selected by the content presentation module 210). In various embodiments, the request from the user includes display instructions specifying how an interface presents information about the selected one or more tasks. For example, a request specifies a calendar view, so the content presentation module 210 generates an interface displaying information about one or more tasks on a calendar, so information identifying a task, or one or more attributes of a task, are displayed on a portion of the calendar corresponding to a date associated with the task (e.g., a due date for the task, a date associated with a most recent modification of the task, etc.). As another example, a request includes a specific attribute of a task, and the content presentation module 210 selects tasks having the specific attribute and generates instructions for an interface presenting the selected tasks.

In various embodiments, the content presentation module 210 receives a request from a user to generate a report via a client device 100. The request includes one or more criteria for content included in the report and a format for displaying content in the report. The content presentation module 210 retrieves content, such as tasks or other data objects accessible to the task management system 130, having attributes that satisfy at least a threshold amount of criteria included in the request. To generate the report, the content presentation module 210 generates instructions that include the retrieved content and instructions for displaying the retrieved content subject to the format included in the report. The content presentation module 210 transmits the instructions for the report to the client device 100, which executes the instructions to generate the report.

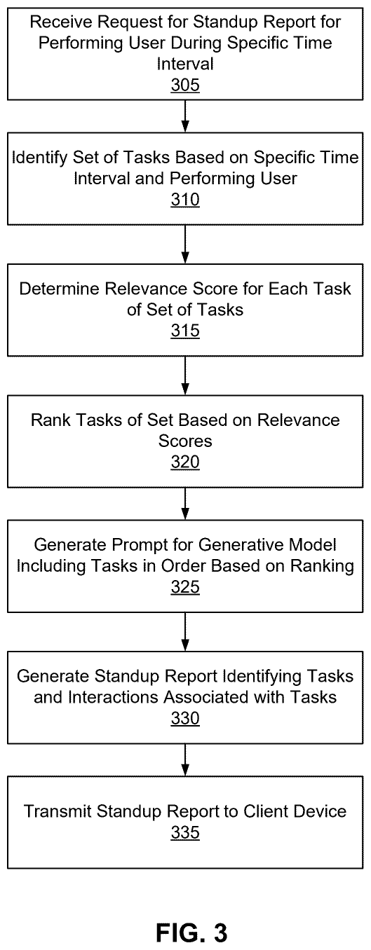

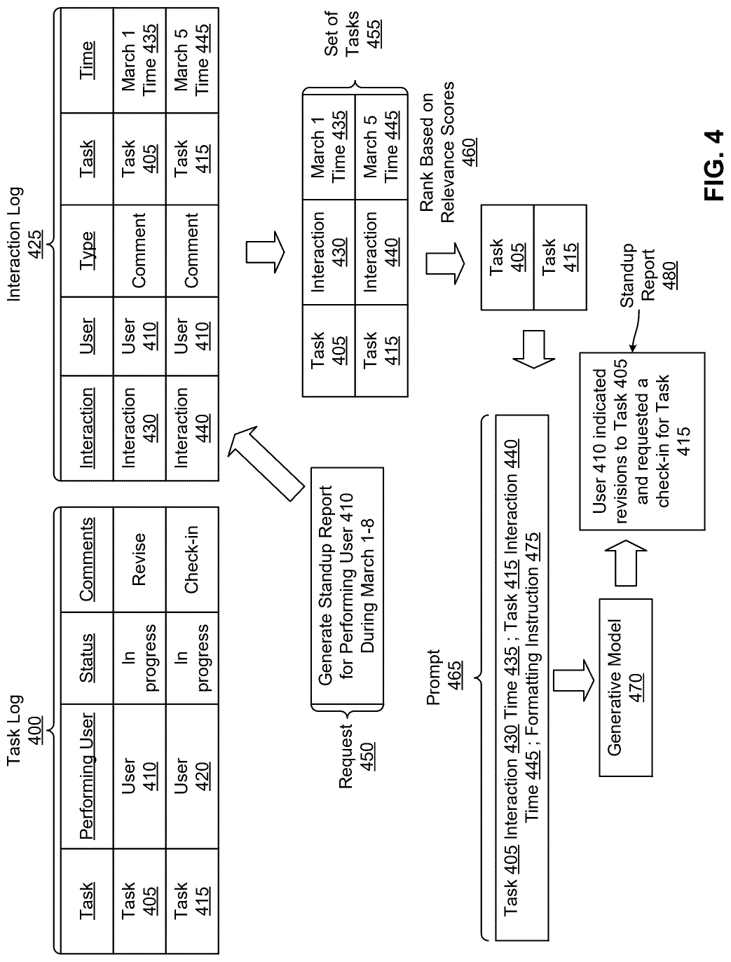

For example, the content presentation module 210 receives a request to generate a standup report from a user. The request identifies a performing user and a specific time interval. In some embodiments, the request also includes a formatting instructions for the standup report. As further described below in conjunction with FIGS. 3 and 4, the content presentation module 210 determines interactions with one or more tasks that are associated with the performing user and with a time in the specific time interval. The content presentation module 210 identifies a set of tasks associated with the determined interactions, so the set of tasks comprises tasks with which the performing user included in the request performed an interaction during the specific time interval included in the request. For each task of the set, the content presentation module 210 determines a relevance score based on attributes of a task and values of the attributes of the task, as further described below in conjunction with FIG. 3. Based on the relevance scores, the content presentation module 210 ranks the tasks of the set and generates a prompt for input to a generative model that generates the standup report from the prompt. As further described below in conjunction with FIGS. 3 and 4, the prompt includes each interaction by the performing user with a task of the set during the specific time interval grouped by corresponding task, with the prompt ordering the tasks of the set based on the ranking. Based on the prompt with the ordered tasks of the set, the generative model generates a standup report that identifies each task of the set and includes descriptive information of interactions the performing user performed with each task of the set in conjunction with each task of the set. A formatting instruction included in the prompt specifies how the standup report identifies different tasks and different interactions with tasks in various embodiments. The content presentation module transmits instructions for generating the standup report to a client device, which executes the instructions to present the standup report.

The search module 220 receives a search query from a client device 100 and retrieves search results comprising tasks, or other data objects, having attributes that at least partially satisfy the search query. Data objects may be documents, video files, audio files, or other files accessible to the search module 200. The data objects may be locally stored in the data store 260 or may be obtained from one or more third party systems 110 the task management system 130 is authorized to access. A search query is text for a word or set of words indicating attributes of a task or another data object. In various embodiments, the search model 220 generates a score for each task, or data object, at least partially satisfying the search query and presents the search results based on their corresponding scores. For example, the search module 220 scores tasks or other data objects based on a measure of relevance of a task or a data object to a search query. For example, the search module 220 applies natural language processing (NLP) techniques to text in the search query to generate a search query embedding representing characteristics of the search query. The search module 220 may use the search query embedding to score candidate items for presentation to a customer (e.g., by comparing a search query embedding to an item embedding) based on measures of similarity (e.g., cosine similarity, dot product, etc.) between the each query embedding and embeddings generated for tasks or data objects.

In some embodiments, a user authorizes the task management system 130 to access information associated with the user and stored by a third party system 110. In various embodiments, the search module 220 stores authentication information for the third party system 110 corresponding to the user in association with an identifier of the user and an identifier of the third party system 130. The authentication information for the third party system 110 may be a combination of a username and password or other authentication information identifying the user to the third party system 110 and indicating the user is authorized to access the third party system 110. In various embodiments, when the search module 220 receives a search query from the user, the search module 220, through one or more application programming interfaces (APIs), accesses a third party system 110 on behalf of the user. The search module 220 transmits the search query to the third party system 110 after accessing the third party system 110 with the authentication information provided by the user and retrieves files or other data objects from the third party system 130 that at least partially satisfy the search query. This allows the search module 220 to evaluate both locally stored data in the data store 260 and data maintained by a third party system 130 for the user for search results, providing search results for a search query that account for data objects associated with the user from one or more third party systems 130 the user authorized the task management system 130 to access.

The access control module 230 regulates access to tasks by various users. When a user accesses the task management system 130, the access control module 230 retrieves a user profile of the user from the user profile store 250. Based on one or more permissions in the user profile, the access control module 230 identifies a subset of tasks from the data store 260 that the permissions in the user profile of the user authorize the user to access. Tasks in the subset may be presented to the user or be otherwise accessible to the user, while tasks in the data store 260 and not in the subset are inaccessible to the user. Hence, the access control module 230 regulate access to stored tasks for different users.

Similarly, for a task, the access control module 230 determines a set of interactions a user is authorized to perform with the task based on one or more permissions in the user profile of the user. For example, a user with a first type of permission is authorized to modify one or more attributes of a task, while another user with a different type of permission is authorized to view the attributes of the task but is unable to modify one or more attributes of the task. As another example, one or more permissions of the user authorize the user to modify a specific set of attributes of the task, while preventing the user from modifying attributes that are not included in the specific set. The access control module 230 may receive permissions or modifications to permissions of a user from the user or from another user and store the permissions or the modified permissions in a user profile corresponding to the user. For example, a user profile of a user identifies an additional user authorized to modify one or more permissions associated with the user. This allows the access control module 230 to regulate types of interactions with a task based on permissions of a user, so different users are capable of performing different types of interactions with different tasks.

The machine learning training module 240 trains machine learning models used by the task management system 130. The task management system 130 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 240 generates the set of parameters for a machine learning model by “training” the machine learning model. Once trained, the machine learning model uses the set of parameters to transform inputs into outputs.

The machine learning training module 240 trains a machine learning model based on a set of training examples. Each training example includes input data to which the machine learning model is applied to generate an output. For example, each training example may include characteristics of a user, attributes of a task, attributes of a data object, data received from a user, or other data. In some cases, the training examples also include a label which represents an expected output of the machine learning model. In these cases, the machine learning model is trained by comparing its output from input data of a training example to the label for the training example.

The machine learning training module 240 may apply an iterative process to train a machine learning model whereby the machine learning training module 240 trains the machine learning model on each of the set of training examples. To train a machine learning model based on a training example, the machine learning training module 240 applies the machine learning model to the input data in the training example to generate an output. The machine learning training module 240 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 240 updates the set of parameters for the machine learning model based on the score generated by the loss function. For example, the machine learning training module 240 may apply gradient descent to update the set of parameters.

In various embodiments, the machine learning training module 240 tunes one or more generative models that receive a text prompt and generate content based on the text prompt. A generative model is a large language model (LLM), such as a generative pre-trained transformer model (GPT) in various embodiments. The generative model may generate text in response to a text prompt in various embodiments. Alternatively or additionally, the generative model selects or generates an image or another type of data in response to a text prompt. A generative model is model pre-trained on a text corpus including text to output text in response to a text prompt from a user before being obtained by the task management system 130. As another example, a generative model is a generative image model pre-rained on a corpus of images to output an image in response to a received text prompt before being obtained by the task management system 130. Obtaining a pre-trained generative model allows the machine learning training module 240 to leverage relationships between different text (or text and images) the generative model learned through application to a text corpus or image corpus including a larger amount of data and more varied data during pre-training than the task management system 130 maintains.

In various embodiments, the machine learning training module 240 generates examples for inclusion in a prompt that is input to a generative model. An example includes an input to the generative model and an expected output in response to the input. For example, an example includes input text and output text, with the output text provided in an expected format for the generative model. In various embodiments, when applying a generative model to input, the task management system 130 (e.g., the content presentation module 210) generates a prompt for the generative model that includes the input and one or more examples generated by the machine learning training module 240. Including the example in the prompt provides the generative model with information about a format or content of the output in the prompt itself. In some embodiments, the machine learning training module 240 generates an index including embeddings corresponding to various examples and corresponding examples to facilitate identification and retrieval of one or more examples to include in a prompt based on an embedding of an input to be provided to a generative model. The machine learning training module 240 stores the index including the supplemental examples, or the embeddings for the supplemental examples in the data store 260 in various embodiments.

The user profile store 250 includes a user profile corresponding to each user of the task management system 130. A user profile of a user includes a user identifier of the user that uniquely identifies the user, characteristics of the user, contact information for the user, or other descriptive information about the user. In various embodiments, the user profile of the user includes task identifiers of tasks associated with the user. Further, in some embodiments, the user profile of the user includes one or more permissions of the user. The one or more permissions included in the user profile of a user identify types of interactions the user is permitted to perform with one or more tasks or tasks that the user is authorized to access. Different permissions may correspond to different tasks, allowing the user to perform different types of interactions with different tasks. A user profile may also maintain references to interactions the corresponding user performed on one or more tasks and that are stored in an interaction log in the data store 260. This allows the user to review or to identify one or more interactions the user previously performed with tasks by accessing the user's user profile.

The data store 260 stores data used by the task management system 130. For example, the data store 260 stores tasks created by a user. In various embodiments, the data store 260 includes a task log that includes a task identifier for each task with corresponding attributes of a task associated with the task identifier. For example, the task log includes multiple entries, with each entry including a task identifier for a task and attributes of the task associated with the task identifier. As further described above, example attributes of the task include: an identifier of a performing user assigned to perform the task, a status of the task, a due date for the task, a priority level of the task, a resource allocation (e.g., a budget) for performing the task, one or more comments about the task, or other information relevant to performing an action corresponding to the task.

Additionally, the data store 260 stores an interaction log describing interactions by users with the task management system 130. The interaction log includes an entry for each interaction by a user with a task. An entry in the interaction log includes a task identifier, a user identifier of a user who performed an interaction, a time when the interaction was performed, and a description of the interaction. The description of the interaction may be a type of the interaction and may include data received through the interaction. For example, an interaction is a comment on a task, and a description of the interaction includes a type indicating a comment and text data comprising the comment. As another example, a description of an interaction includes an attribute of a task modified by the interaction and a modified value for the attribute received via the interaction. In various embodiments, the interaction log organizes entries chronologically, while in other embodiments, the interaction log may organize entries using other formats.

The data store 260 also stores trained machine learning models trained by the machine learning training module 240. For example, the data store 260 may store the set of parameters for a trained machine learning model on one or more non-transitory, computer-readable media. As another example, the data store 260 stores parameters comprising a previously trained model that the machine learning training module 240 obtained from a third party 110 or from another source. For example, the data store 260 includes a generative model, such as a large language model (LLM) that the machine learning training module 240 obtained from a third party system 130. The data store 260 may also include one or more examples that a machine learning model, such as a generative model receives as input. In various embodiments, the data store 260 stores an index including various examples and corresponding embeddings of the examples to facilitate retrieval of an example. The data store 260 uses computer-readable media to store data, and may use databases to organize the stored data.

FIG. 3 is a flowchart of a method for generating a standup report identifying interactions performed by a user with tasks during a specified time interval, in accordance with some embodiments. Alternative embodiments may include more, fewer, or different steps from those illustrated in FIG. 3, and the steps may be performed in a different order from that illustrated in FIG. 3. These steps may be performed by the task management system 130, or by another online system, in various embodiments. Additionally, each of these steps may be performed automatically by the task management system 130 without human intervention.

As further described above in conjunction with FIG. 2, the task management system 130 stores tasks created by one or more users. A task identifies an action to be performed and is associated with a performing user assigned to perform the action. Additionally, a task has one or more attributes. Example attributes of a task include: the performing user assigned to the task, a status of the task, a due date for the task, a priority level of the task, a resource allocation (e.g., a budget) for performing the task, one or more comments about the task, or other information relevant to performing an action corresponding to the task. As a user may create multiple tasks and associate one or more different performing users with various tasks, determining progress towards different tasks having different performing users or identifying progress by a performing user on different tasks associated with the performing user is time consuming for the user. For the user to identify or to review interactions a performing user has performed with different tasks, the task management system 130 receives multiple inputs from the user to locate individual tasks associated with the performing user and identify interactions performed with various tasks. Similarly, for a performing user to summarize previously performed interactions with different tasks, the performing user provides multiple inputs to the task management system 130 to identify previously performed interactions and the tasks with which the previously performed interactions were performed.

To simplify a user determining progress on various tasks, the task management system 130 receives 305 a request from the user to generate a standup report for a performing user during a specific time interval. As further described below, the standup report identifies tasks with which the performing user performed at least one interaction during the specific time interval and describes the interactions the performing user performed with each of the identified tasks during the specific time interval. The request includes information identifying a performing user and the specific time interval. In some embodiments, the request also includes a formatting instruction specifying a format in which the standup report presents information identifying tasks and interactions with tasks during the specific time interval. For example, the formatting instruction specifies a level of detail the standup report includes for each interaction performed by the performing user or indicates an organizational structure for the standup report to identify tasks and interactions with tasks. The user may select a formatting instruction from a predefined set of formatting instructions maintained by the task management system 130 or may receive a manually specified formatting instruction from the user in various embodiments. In some embodiments, the user selects the specific time interval from a set of time intervals corresponding to different lengths of time that the task management system 130 presents to the user. Alternatively, the user manually specifies the time interval included in the request.

Based on the received request, the task management system 140 identifies 310 a set of tasks from an interaction log in a data store 260. As further described above in conjunction with FIG. 2, the interaction log includes entries for each interaction performed through the task management system 130 with a task by users of the task management system 130. Hence, each entry in the interaction log corresponds to an interaction with a task by a user, and each entry includes an identifier of an interaction, a task identifier of a task with which the interaction was preformed, a user identifier of a user who performed an interaction, a time when the interaction was performed, and a description of the interaction. The description of the interaction may be a type of the interaction and may include data received through the interaction, such as a value for an attribute of the task received via the interaction.

The set of tasks identified 310 by the task management system 130 based on the received request comprises tasks with which the performing user identified in the request performed an interaction during the specific time interval included in the request. So each task of the set includes a task associated with an interaction performed by the performing user and associated with a time within the specific time interval. In some embodiments, the task management system 130 identifies 310 a set of tasks where an interaction by the performing user during the specific time interval changed an attribute of the task, allowing the set of tasks to include tasks where an interaction by the performing user changed at least one attribute of the task. Hence, the task management system 130 leverages the stored interaction log of interactions by users with tasks to identify 310 a set of tasks with which the performing user performed an interaction during the specific time interval.

While the set of tasks identifies tasks with which the performing user performed at least one interaction during the specific time interval, different types of interactions with different tasks have different levels of relevance to the user in assessing performance of tasks by the performing user. For example, an interaction by the performing user with a task that is assigned to the performing user is more relevant to the user assessing task performance of the performing user than an interaction by the performing user with a different task assigned to a different performing user. To account for differing in levels of relevance of different interactions by the performing user to the user requesting the standup report, the task management system 130 determines 315 a relevance score of each task of the set to the user. Based on the relevance scores, the task management system 130 ranks 320 the tasks of the set.

To determine 315 a relevance score of a task of the set, the task management system 130 maintains weights corresponding to each attribute of a task or corresponding to each of at least a subset of attributes of the task. For each attribute, or for each of a subset of attributes, of a task of the set, the task management system 140 applies a weight corresponding to an attribute of the task of the set to a value of the attribute of the set for the task. In various embodiments, the task management system 140 determines 315 the relevance score of the task of the set by multiplying a value of each attribute of the task of the set by the corresponding weight of each attribute of the set and combining the weighted values of the attributes of the task. For example, the measure of relevance of the task of the set is a weighted sum of the values for each of a subset of attributes of the task based on the weights corresponding to each attribute of the subset. In various embodiments, a higher weight corresponding to an attribute of the task indicates the attribute provides a greater indication of whether the task is relevant to the user. For example, an attribute indicating whether the task of the set was assigned to the performing user is assigned a maximum weight.

In some embodiments, the task management system 130 generates one or more attributes of a task based on information associated with the task in the interaction log and in the task log. For example, an attribute of a task is an indication whether the performing user is assigned the task. Such a value may have a first value when the performing user is assigned to perform the task and have a second, different, value when the performing user is not assigned to perform the task. As another example, an attribute of a task is a number of comments associated with the task, which the task management system 130 determines by summing each entry in the interaction log indicating a comment was received for the task. In some embodiments, the task management system 130 determines a number or comments associated with the task during the specific time interval as an attribute of the task. Additionally or alternatively, an attribute of a task is a total number of interactions with the task determined from a number of entries in the interaction log including a task identifier of the task. The task management system 130 may similarly determine a total number of interactions with the task during the specific time interval in some embodiments. Different or additional attributes of a task may be determined based on information the task management system 130 stores in association with the task in various embodiments.

The task management system 130 may apply a trained generative model to the attributes of tasks to determine weights for different attributes. As further described above in conjunction with FIG. 2, the generative model is pre-trained on a large text corpus before being obtained by the task management system 130. For example, the generative model is a large language model (LLM), such as a generative pre-trained transformer (GPT) language model. Based on the pre-training, the generative model learned relationships between different portions text and leverages the learned relationships to generate output text in response to a received text prompt. The task management system 130 generates a ranking prompt for the generative model that identifies each attribute of a task and a request to select a subset of attributes relevant to the user and to rank the subset of attributes. The generative model generates a ranking of attributes of tasks received in the ranking prompt. Based on the ranking of attributes, the task management system 130 determines weights for attributes, with attributes having higher positions in the ranking having larger weights. The task management system subsequently applies the determined weights for different attributes to corresponding values of the different attributes for a task to determine 315 the relevance score for the task.

Based on the relevance score determined 315 for each task of the set, the task management system 130 ranks 320 the tasks of the set. In various embodiments, tasks with higher relevance scores have higher positions in the ranking, so a task of the set with a maximum relevance score has a highest position in the ranking, while a task of the set with a minimum relevance score having a minimum position in the ranking. Based on the ranking, the online concierge system 140 generates 325 a prompt for a generative model. The prompt includes an instruction to generate the standup report and the tasks of the set in an order specified by the ranking 315, with each interaction by the performing user with a task of the set during the specific time interval included with a corresponding task. For example, the prompt includes an identifier of a task of the set and each interaction by the performing user with the task of the set during the specific time interval, then includes an identifier of an additional task of the set and each interaction by the performing user with the additional task of the set during the specific time interval. Hence, the prompt includes tasks of the set and corresponding interactions by the performing user with the tasks of the set during the specific time interval in an order specified by the ranking.

Generating the prompt so the tasks of the set and their corresponding interactions based on the ranking 315 allows the prompt to indicate a relative importance of different tasks of the set relative to each other to the user requesting the standup report. Without ordering the tasks of the set in the prompt based on their relevance scores, the generative model has insufficient information to determine how to optimally organize the tasks in the standup report. Many generative models inaccurately reorder received inputs when summarizing the received inputs, so ranking the tasks of the set based on their relevance scores to order the tasks and their interactions in the prompt allows the generative model to leverage an ordering of the tasks int eh prompt when organizing tasks in the standup report.

Additionally, when generating 325 the prompt, the task management system 130 includes a formatting instruction describing a format for presenting information in the standup report. In various embodiments, the task management system 130 appends the formatting instruction to the tasks of the set and their corresponding interactions. The formatting instruction is included in the request for the standup report in some embodiments, while in other embodiments, the formatting instruction is specified by the task management system 130. For example, the user selects a specific formatting instructions from a set of formatting instructions maintained by the task management system 130 that is included in the request. In some embodiments, the task management system 130 appends an example corresponding to the formatting instruction to the prompt in addition to the tasks of the set and their corresponding interactions. The example includes example tasks and interactions and an example standup report for the example tasks and interactions. The example may be retrieved from the data store 260 in various embodiments. Including an example corresponding to the formatting instructions provides the generative model with an indication of an expected format for presenting tasks and interactions in the standup report based on the example tasks and the example standup report corresponding to the formatting instruction.

The task management system 130 applies a generative model, such as a large language model (LLM), to the prompt, and the generative model generates 330 the standup report based on the tasks of the set and corresponding interactions included in the prompt. The resulting standup report includes information identifying tasks of the set and descriptions of corresponding interactions by the performing user during the specific time interval according to the formatting instruction in the prompt. The standup report generated 330 by the generative model displays interactions by the performing user included in the prompt so the interactions are grouped based on their corresponding task of the set. Further, the standup report orders the tasks of the set, with their corresponding interactions, based on the order determined by the ranking based on relevance scores. For example, the standup report includes a task identifier of a task of the set and interactions by the performing user with the task of the set during the specific time interval displayed in conjunction with the task. Hence, the standup report organizes interactions by the performing user based on tasks of the set during the specific time interval with which the interactions were performed to simplify identification and review of interactions the performing user performed with different tasks during the specific time interval.

In some embodiments, the generative model generates a summary of one or more interactions with a task of the set that is included in the standup report. For example, one or more interactions by the performing user with a task of the set during the specific time interval are comments comprising text received from the performing user. The generative model generates a summary of the comments based on their constituent text and includes the summary of the comments in the standup report rather than the individual comments. Such summarization may further simplify review of interactions with a task of the set by the performing user during the specific time interval when viewing the standup report.

The task management system 130 transmits 335 the standup report to a client device 100 of the user. Subsequently, the client device 100 displays, or otherwise presents, the standup report to the user. For example, a task management application executing on the client device 100 generates an interface that presents the standup report to the user.

FIG. 4 is a process flow diagram of one embodiment of a method for generating a standup report identifying interactions performed by a user with tasks during a specified time interval by a task management system 130. As further described above in conjunction with FIGS. 1-3, the task management system 130 receives tasks from users. Each task identifies an action to be performed and includes a performing user assigned to perform the action. Further, each task is associated with one or more attributes providing information about the task, as further described above in conjunction with FIGS. 1-3.

The task management system 130 stores a task log 400 in a data store 260 to identify received tasks. In various embodiments, the task log 400 includes multiple entries, with each entry corresponding to a task. An entry in the task log 400 includes a task identifier of a task, a performing user assigned to perform the task (e.g., a user identifier of the performing user), and one or more attributes of the task. For purposes of illustration, the task log 400 shown in FIG. 4 includes task 405, with user 410 assigned to perform task 405. Additionally, the task log 400 shown in FIG. 4 includes attributes for task 405 comprising a status of “in progress” and a comment of “revise.” Similarly, the example of FIG. 4 shows task log 400 also including task 415, with user 420 assigned to perform task 405 and with task 415 having attributes of a status of “in progress” and a comment of “check-in.” However, in other embodiments, the task log 400 includes different or additional attributes of tasks than the examples shown in FIG. 4. Other example attributes of a task may include: an identifier of a user who created a task, a due date for the task, a priority level of the task, a resource allocation (e.g., a budget) for performing the task, or other information relevant to performing an action corresponding to the task.

When performing an action corresponding to a task, a performing user performs one or more interactions with a task. In various embodiments, an interaction with a task modifies a value of one or more attributes of the task or generates an additional attribute for the task. For example, an interaction with task 405 changes the status of task 405 from “in progress” to “closed.” As another example, an interaction with task 415 generates an additional comment that is stored in the task log 400 in association with task 415. Hence, interactions with a task provides information about progress on performance of an action corresponding to the task.

As performing users perform interactions with tasks, the task management system 130 generates an interaction log 425 comprising entries that each correspond to an interaction with a task by a performing user. In various embodiments, each entry in the interaction log 425 stores an identifier of an interaction, a user identifier of user who performed the interaction, a task identifier of a task on which the interaction was performed, a time when the interaction was performed, and a description of the interaction. Different information describing an interaction with a task may be included in an entry in the interaction log 425. For purposes of illustration, the example interaction log 425 in FIG. 4 includes an entry for interaction 430 that indicates user 410 performed interaction 430 on task 405 at time 435 (which is “March 1” in the example of FIG. 4). Similarly, FIG. 4 shows an example where the interaction log 425 includes another entry for interaction 440 indicating that user 410 performed interaction 440 on task 415 at time 445 (“March 8” in the example of FIG. 4).

To monitor performance of actions for different tasks, a user may request a standup report for a performing user during a specific time interval. The standup report identifies interactions with tasks that the performing user performed during the specific time interval. In various embodiments, the standup report identifies each task with which the performing user performed at least interaction during the specific time interval and includes a description of the corresponding interactions performed with each task during the specific time interval. Conventionally, a performing user manually identifies interactions with tasks performed during the specific time interval, or the user requesting the standup report reviews individual tasks to identify interactions performed by the performing user. However, these conventional methods are time- and labor-intensive for the performing user or for the user requesting the standup report.

The task management system 130 leverages the task log 400 and the interaction log 425 to more efficiently generate a standup report for a performing user. In various embodiments, the task management system 130 receives a request 450 for a standup report that identifies a performing user and a specific time interval. For example, a user selects an interface element for generating a standup report in an interface displayed by a client device 100 and inputs a user identifier of the performing user and the specific time interval via the interface. In some embodiments, an interface presented to the user includes an interface element from which the user identifies the specific time interval. For example, the interface element identifies different predefined time intervals (e.g., a current week, a current month, etc.) or allows the user to specify a starting time and an ending time. Based on the received input, the client device 100 transmits the request 450 including the user identifier of the performing user and the specific time interval to the task management system 130. However, in other embodiments, the user generates the request 450 using additional or alternative methods. For purposes of illustration, FIG. 4 shows the request 450 identifying user 410 and a specific time interval of March 1 through March 8, for purposes of illustration.

In response to receiving the request 450, the task management system 130 identifies a set 455 of tasks based on the request 450 and the interaction log 425. The set 455 of tasks includes tasks with which the performing user included in the request 450 performed at least one interaction during the specific time interval included in the request 450. So the task management system 130 identifies entries in the interaction log 425 including interactions performed by the performing user included in the request 450 during the specific time interval included in the request 450 and identifies tasks included in the identified entries for the set 455 of tasks. In some embodiments, the set 455 of tasks includes tasks with which the performing user included in the request 450 performed an interaction that modified an attribute of a task during the specific time interval included in the request 450; such embodiments limit the set 455 of tasks to tasks having at least one attribute modified by an interaction by performing user included in the request 450 during the specific time interval included in the request 450.

In the example of FIG. 4, the request 450 identifies user 410 and a specific time interval of March 1 through March 8. The example interaction log 425 in FIG. 4 includes interaction 430 performed by user 410 with task 405 on March 1 and interaction 440 performed by user 410 with task 415 on March 8. Both interaction 430 and interaction 440 were performed by user 410 at times within the specific time interval of March 1 through March 8, so the task management system 130 identifies task 405, on which interaction 430 was performed, and task 415, on which interaction 440 was performed, as the set 455 of tasks.

While the set 455 of tasks includes tasks with which the performing user included in the request 450 performed an interaction during the specific time interval included in the request 450, different interactions by the performing user included in the request 450 provide different amounts of information to the user from whom the request 45 was received about performance of tasks by the performing user included in the request 450. For example, an interaction by the performing user included in the request 450 with a task that is assigned to the performing user included in the request 450 is more relevant to assessing actions taken by the performing user included in the request 450 than an interaction by the performing user included in the request 450 with another task assigned to a different performing user. To account for variations in relevance of different interactions by the performing user included in the request 450 when generating the standup report, the task management system 130 determines a relevance score for each task of the set 455 and ranks the tasks by their corresponding relevance scores. A relevance score for a task of the set 455 is based on values of attributes of the task of the set 455.

As further described above in conjunction with FIG. 3, the task management system 130 associates different weights with different attributes of a task. To determine a relevance score for the task, the task management system 130 applies a corresponding weight for an attribute to a value of each attribute and combines the weighted values of the attributes. For example, the relevance score for a task is a weighted sum of values of attributes of the task with corresponding weights applied. In various embodiments, a higher weight for an attribute of the task indicates the attribute provides a greater indication of whether the task is relevant to the user from whom the request 450 was received. For example, an attribute indicating whether a task was assigned to the performing user included in the request 450 has a maximum weight relative to weights for other attributes.

In some embodiments, the task management system 130 may apply a trained generative model to the attributes of tasks when determining weights for different attributes, as further described above in conjunction with FIG. 3. The task management system 130 generates a ranking prompt for the generative model that identifies each attribute of a task and a request to select a subset of attributes relevant to the user. The generative model generates a ranking of attributes of tasks, and the task management system 130 determines weights for attributes based on the ranking of attributes, with attributes having higher positions in the ranking having larger weights. The task management system 130 subsequently applies the determined weights for different attributes to corresponding values of the different attributes for a task to generate the relevance score for the task.

Based on the relevance score for each task of the set 455, the task management system 130 ranks 460 the tasks of the set 455. In the example of FIG. 4, task 405 has a higher relevance score than task 415, as an attribute of task 405 indicates task 405 was assigned to the performing user included in the request 450 (user 410), while task 415 was not assigned to the performing user included in the request 450 (user 410). When ranking 460 the tasks of the set 455, tasks with higher relevance scores have higher positions in the ranking.

The task management system 130 uses the ranking 460 of the tasks of the set 455 to generate a prompt 465 for a generative model 470. The prompt 465 includes each task of the set 455 in the order specified by the ranking 460. In conjunction with a task of the set 455, the prompt 465 includes each interaction with the task of the set 455 by the performing user included in the request 450 during the specific time interval included in the request 450, with the tasks of the set 455 included in the prompt 465 in the order specified by the ranking 460. Hence, the prompt 465 includes interactions by the performing user included in the request 450 with tasks of the set 455 during the time interval included in the request 450, with the interactions grouped based on a corresponding task of the set 455 with which they were performed, and the tasks of the set 455 ordered based on the ranking 460. In various embodiments, the prompt 465 includes text data identifying each task of the set 455 and describing corresponding interactions with tasks of the set 455 by the performing user included in the request 450 during the specific time interval included in the request 450.

In the example of FIG. 4, the prompt 465 initially identifies task 405, which has a highest position in the ranking 460 and description of interactions by the performing user included in the request 450 with task 405 during the specific time interval included in the request 450 (e.g., interaction 430 at time 435). Subsequently, the prompt 465 identifies task 415, which has a lower position in the ranking 460 than task 405, and descriptive information of interactions by the performing user included in the request 450 with task 415 during the specific time interval included in the request 450 (e.g., interaction 440 at time 445). In various embodiments, the prompt 465 includes delimiter characters to differentiate between interactions associated with one task and interactions associated with another task.

As further described above in conjunction with FIGS. 2 and 3, the generative model 470 receives the prompt 465, which comprises text, and generates text content based on the prompt 465. In various embodiments, the generative model 470 is a large language model (LLM), such as a generative pre-trained transformer model (GPT). The generative model 470 is pre-trained to output text in response to a text prompt from a user through application to a text corpus including text prior to being stored by the task management system 130. Pre-training allows the generative model 470 to generate output based on a received prompt and relationships between text in the received prompt the generative model 470 learned when applied to the text corpus. Hence, based on the prompt 465, the generative model 470 generates the standup report 480 that identifies each task of the set 455 and describes interactions by the performing user included in the request 450 with various tasks of the set 455 during the specific time interval included in the request 450.

In some embodiments, the prompt 465 also includes a formatting instruction 475 that is appended to the interactions by the performing user included in the request 450 with tasks during the time interval included in the request 450. The generative model 470 uses the formatting instruction 475 to determine how to group and to display the tasks of the set 455 and corresponding interactions with tasks of the set 455 by the performing user identified in the request 450. For example, a particular value for the formatting instruction 475 causes the generative model 470 to generate a standup report 480 displaying interactions with a task of the set 455 as a bulleted list associated with a task identifier of the task of the set 455. In other examples, different formatting instructions 475 modify an amount of detail the standup report 480 displays for various interactions with tasks of the set 455.

For example, the user selects a formatting instruction through one or more interface elements presented to the user, with each interface element corresponding to a different formatting instruction. For example, the interface displays three interface elements: an interface element for a bulleted list for displaying the tasks of the set 455, an additional interface element for displaying limited information about the tasks of the set 455, and an alternative interface element for displaying detailed information about the tasks of the set 455. Different numbers of interface elements corresponding to different formats for presenting the tasks of the set 455 may be presented to the user in various embodiments to provide the user with options for an amount of detail and a format in which tasks of the set 455 are presented in the standup report 480.

The formatting instruction 475 may be an example appended to the interactions by the performing user included in the request 450 in various embodiments. The example includes example tasks and interactions and an example format for presenting the example tasks and interactions. In some embodiments, the task management system 130 receives a selection of a formatting instruction from a set of formatting instructions displayed to the user, retrieves an example corresponding to the selected formatting instruction, and includes the retrieved example in the prompt 465. This allows the user from whom the request 450 was received to customize how the standup report 480 identifies interactions by the performing user identified in the request 450 and to leverage one or more formatting configurations maintained by the task management system 130. Alternatively, the user from whom the request 450 was received may manually specify the formatting instruction 475. For example, the user includes a user-generated example including example tasks and interactions and an example report displaying the example tasks and interactions to further customize how the standup report 480 displays interactions by the performing user included in the request 450 with tasks of the set 455 during the specific time interval included in the request 450.

For example, the standup report 480 identifies each task of the set 455. In conjunction with each task of the set 455, the standup report 480 displays information describing interactions with a task of the set 455 by the performing user included in the request 450 during the specific time interval included in the request 450. For example, the standup report 480 displays a task name or a task identifier of the set 455 and displays information describing at least a set of interactions the performing user identified by the request 450 performed with the task corresponding to the task name or the task identifier during the specific time interval included in the request 450 proximate to the task name or the task identifier. In the example of FIG. 4, the standup report 480 includes a user identifier of the performing user included in the request 450 (User 410), and includes a task identifier of task 405 in conjunction with a description of the interaction the performing user included in the request 450 with task 405 (e.g., interaction 430, which was a comment of “revise”). Similarly, the standup report 480 includes a task identifier of task 405 in conjunction with a description of the interaction the performing user included in the request 450 with task 415 (e.g., interaction 440, which was a comment of “check-in”). In the example of FIG. 4, the standup report 480 of “User 410 indicated revisions to task 405 and requested a check-in for task 415” identifies user 410 and limited description of interactions that user 410 performed with task 405 and task 415. In other embodiments, the standup report 480 includes additional details about task 405 and task 415, or presents the description of interactions performed with task 405 and task 415 in a list or in another format segmented by tasks.

The task management system 130 simplifies generation of the standup report by identifying the set 455 of tasks based on interactions by the performing user included in the request 450 with tasks during the specific time interval included in the request 450 and ordering the tasks of the set 455 so the standup report more prominently presents interactions providing more information about performance of actions. As many generative models may be inaccurate when reordering data in a prompt, ordering the tasks of the set 455 based on their relevance scores allows the resulting standup report 480 to preserve an ordering of the tasks of the set 455. Basing relevance scores for tasks on values of attributes for the tasks weighted by attribute-specific weights allows the task management system 130 to use different attributes of tasks as a proxy for the likely relevance of a task to a user requesting the standup report 480 when ordering tasks.

### ADDITIONAL CONSIDERATIONS

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a non-transitory computer readable medium, comprising:
storing, at the computer system, tasks identifying actions to be performed, each task associated with one or more users to perform an action and each task having one or more attributes;
storing, at the computer system, an interaction log identifying interactions by the one or more users with one or more tasks, each interaction associated with a user identifier of a user who performed an interaction, a task associated with the interaction, a time when the interaction was performed, and a description of the interaction,
receiving, at the computer system, a request to generate a standup report from a client device of a user, the request including a specific time interval and identifying a performing user;
identifying a set of tasks based on the request and the interaction log, each task of the set associated with an interaction associated with the performing user and associated with a time within the specific time interval;
determining a relevance score for each task of the set of tasks, the relevance score for a task of the set based on values of attributes of the task of the set and weights corresponding to different attributes of the task of the set;
ranking the tasks of the set based on the relevance scores;
generating a prompt for a generative model to generate the standup report, the prompt including each task of the set with associated interactions by the performing user during the specific time interval, the tasks of the set included an order specified by the ranking; and
generating the standup report for the performing user, the standup report identifying tasks of the set in the order specified by the ranking with a description of one or more interactions by the performing user with each task of the set during the specific time interval included in conjunction with a corresponding task of the set; and
transmitting the standup report to the client device of the user for presentation.

2. The method of claim 1, wherein determining the relevance score for each task of the set comprises:
or for each of a subset of attributes of the task of the set, applying a weight corresponding to an attribute of the task of the set to a value of the attribute of the task of the set; and
determining the relevance score for the task of the set as a sum of the weighted values of the subset of attributes of the task of the set.

3. The method of claim 2, wherein applying the weight corresponding to the attribute of the task of the set to the value of the attribute of the task of the set comprises:
applying the generative model to a prompt including a ranking instruction to rank attributes and including the attributes of the task, the generative model outputting a ranking of the attributes of the task;
determining the weight for the attribute based on a position of the attribute in the ranking of the attributes of the task; and
applying the weight for the attribute to the value of the attribute.

4. The method of claim 1, wherein an attribute of the task of the set comprises an indication whether the performing user was assigned to perform an action identified by the task of the set.

5. The method of claim 1, wherein an attribute of the task of the set comprises a number of comments received for the task of the set.

6. The method of claim 1, wherein an attribute of the task of the set comprises a number of interactions associated with the task of the set.

7. The method of claim 1, wherein the request includes a formatting instruction for the standup report.

8. The method of claim 7, wherein generating the prompt for the generative model comprises appending an example corresponding to the formatting instruction to the tasks of the set with associated interactions by the performing user during the specific time interval, the example including example tasks and an example standup report.

9. The method of claim 1, wherein identifying the set of tasks based on the request and the interaction log comprises:
identifying interactions from the interaction log associated with the performing user that changed at least one attribute of a task and associated with a time during the specific time interval; and
identifying the set of tasks as tasks associated with the identified interactions.

10. A computer program product comprising a non-transitory computer readable storage medium having instructions encoded thereon that, when executed by a processor, cause the processor to perform steps comprising:
storing, at a task management system, tasks identifying actions to be performed, each task associated with one or more users to perform an action and each task having one or more attributes;
storing, at the task management system, an interaction log identifying interactions by the one or more users with one or more tasks, each interaction associated with a user identifier of a user who performed an interaction, a task associated with the interaction, a time when the interaction was performed, and a description of the interaction,
receiving, at the task management system, a request to generate a standup report from a client device of a user, the request including a specific time interval and identifying a performing user;
identifying a set of tasks based on the request and the interaction log, each task of the set associated with an interaction associated with the performing user and associated with a time within the specific time interval;
determining a relevance score for each task of the set of tasks, the relevance score for a task of the set based on values of attributes of the task of the set and weights corresponding to different attributes of the task of the set;
ranking the tasks of the set based on the relevance scores;
generating a prompt for a generative model to generate the standup report, the prompt including each task of the set with associated interactions by the performing user during the specific time interval, the tasks of the set included an order specified by the ranking; and
generating the standup report for the performing user, the standup report identifying tasks of the set in the order specified by the ranking with a description of one or more interactions by the performing user with each task of the set during the specific time interval included in conjunction with a corresponding task of the set; and
transmitting the standup report to the client device of the user for presentation.

11. The computer program product of claim 10, wherein determining the relevance score for each task of the set comprises:
or for each of a subset of attributes of the task of the set, applying a weight corresponding to an attribute of the task of the set to a value of the attribute of the task of the set; and
determining the relevance score for the task of the set as a sum of the weighted values of the subset of attributes of the task of the set.

12. The computer program product of claim 11, wherein applying the weight corresponding to the attribute of the task of the set to the value of the attribute of the task of the set comprises:
applying the generative model to a prompt including a ranking instruction to rank attributes and including the attributes of the task, the generative model outputting a ranking of the attributes of the task;
determining the weight for the attribute based on a position of the attribute in the ranking of the attributes of the task; and
applying the weight for the attribute to the value of the attribute.

13. The computer program product of claim 10, wherein an attribute of the task of the set comprises an indication whether the performing user was assigned to perform an action identified by the task of the set.

14. The computer program product of claim 10, wherein an attribute of the task of the set comprises a number of comments received for the task of the set.

15. The computer program product of claim 10, wherein an attribute of the task of the set comprises a number of interactions associated with the task of the set.

16. The computer program product of claim 10, wherein the request includes a formatting instruction for the standup report.

17. The computer program product of claim 16, wherein generating the prompt for the generative model comprises appending an example corresponding to the formatting instruction to the tasks of the set with associated interactions by the performing user during the specific time interval, the example including example tasks and an example standup report.

18. The computer program product of claim 10, wherein identifying the set of tasks based on the request and the interaction log comprises:
identifying interactions from the interaction log associated with the performing user that changed at least one attribute of a task and associated with a time during the specific time interval; and
identifying the set of tasks as tasks associated with the identified interactions.

19. A system comprising:
a processor; and
a non-transitory computer readable storage medium having instructions encoded thereon that, when executed by the processor, cause the processor to perform steps comprising:
storing, at a task management system, tasks identifying actions to be performed, each task associated with one or more users to perform an action and each task having one or more attributes;
storing, at the task management system, an interaction log identifying interactions by the one or more users with one or more tasks, each interaction associated with a user identifier of a user who performed an interaction, a task associated with the interaction, a time when the interaction was performed, and a description of the interaction,
receiving, at the task management system, a request to generate a standup report from a client device of a user, the request including a specific time interval and identifying a performing user;
identifying a set of tasks based on the request and the interaction log, each task of the set associated with an interaction associated with the performing user and associated with a time within the specific time interval;
determining a relevance score for each task of the set of tasks, the relevance score for a task of the set based on values of attributes of the task of the set and weights corresponding to different attributes of the task of the set;
ranking the tasks of the set based on the relevance scores;
generating a prompt for a generative model to generate the standup report, the prompt including each task of the set with associated interactions by the performing user during the specific time interval, the tasks of the set included an order specified by the ranking; and
generating the standup report for the performing user, the standup report identifying tasks of the set in the order specified by the ranking with a description of one or more interactions by the performing user with each task of the set during the specific time interval included in conjunction with a corresponding task of the set; and
transmitting the standup report to the client device of the user for presentation.

20. The system of claim 19, wherein determining the relevance score for each task of the set comprises:
or for each of a subset of attributes of the task of the set, applying a weight corresponding to an attribute of the task of the set to a value of the attribute of the task of the set; and
determining the relevance score for the task of the set as a sum of the weighted values of the subset of attributes of the task of the set.
